(19) United States
(12) Patent Application Publication
(10) Pub. No.: US 2008/0137838 A1
(43) Pub. Date: Jun. 12, 2008

(54) PORTABLE STORAGE DEVICE AND SYSTEM WITH HARDWARE KEY AND COPYRIGHT MANAGEMENT FUNCTION

(75) Inventor: Jen-Wei Lo, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: PHISON ELECTRONICS CORP., Chutung Town (TW)

(21) Appl. No.: 11/567,725

(22) Filed: Dec. 6, 2006

(51) Int. Cl. H04L 9/28

(52) U.S. Cl. 380/28

(57) ABSTRACT

A portable storage device and system with hardware key and copyright management function is disclosed, which comprises an encryption and copyright setting software and a portable storage device. The encryption and copyright setting software is adopted for encrypting application programs or digital data. The portable storage device comprises an encryption chip controller and a flash memory, and is adopted for storing the encrypted application programs or digital data so that the portable storage device can serves as a dispersing carrier, a hardware key and an encrypting device with digital copyright management function or network authorization and verification function.

### BACKGROUND OF THE INVENTION

1. Field of the Invention

The present invention relates to a portable storage device and system, and more particularly to a portable storage device and system comprising an encryption chip controller and encryption and copyright setting software for encrypting the application programs or digital data and storing the encrypted application programs or digital data into the portable device.

2. Description of Related Art

With the rapid development of the computer information technology, the electronic products have become an essential part of our life. Accordingly, computer, mobile phone, memory stick, digital camera and other electronic devices are popularly used nowadays. The functions of the above electronic devices are increasing to provide convenience to the users. The electronic devices are equipped storage devices for storing data. Because flash memory has some characteristics, like non-volatile, shock-proof and high storage density, it has replaced EEPROM or other memory with the battery power supply in many portable electronic devices. The rapidly developed semiconductor technology made it possible to increase the storage density and transmission speed of the flash memory. The flash memory is widely used and replaced the hard disk and other conventional storage media.

The portable stick has become a multi-media electronic device after its progressive improvement. The portable stick is designed to be lighter, thinner, shorter and smaller. However, the miniaturized portable stick may easily be misplaced. If the portable stick is misplaced, an unauthorized person may find it and may access the portable stick to retrieve the data stored therein. Furthermore, because people take the Intellectual Property Right seriously, the manufacturer invested lots of the energy and material to develop protection technique in both hardware and software. The most common protection technique is to store software into a CD. When a user installs a computer for the first time, the computer asks the user to input a serial number or a registration code to confirm whether or not a legal user to reduce the chance of pirating. But taking the CD as a carrier to protect software may be still duplicated, illegally sold or dispersed. The CD itself cannot generate a key to verify such illegal behavior with a remote service, or encrypts or decrypts to programs or data.

Therefore, how to use the flash memory to verify or authenticate whether or not a user is legal is an important issue for the manufacturers in the field.

### SUMMARY OF THE INVENTION

According to an aspect of the present invention, the portable storage device and system comprises encryption and copyright setting software for encrypting application programs or digital data and storing into the portable storage device. Thus, the portable storage device can service as a carrier for dispersing the application programs and digital data.

According to another aspect of the present invention, the portable storage device and system comprises an encryption chip controller, so that the portable storage device can service as an anti-pirating hardware key or an encrypting device with digital copyright management function or network authorization and verification function. Thus, the application programs or digital data cannot be duplicated, dispersed or used by an unauthorized user.

### BRIEF DESCRIPTION OF THE DRAWING

FIG. 1 is a block diagram of the portable storage device and system according to an embodiment of the present invention.

FIG. 2 is a block diagram of the portable storage device and system according to an embodiment of the present invention.

FIG. 3 is a procedure for executing the copyright management according to an embodiment of the present invention.

FIG. 4 is a procedure for executing the portable device as the hardware key according to an embodiment of the present invention.

FIG. 5 is a procedure for renewing the copyright or the authorization according to an embodiment of the present invention.

### DETAIL DESCRIPTION OF THE INVENTION

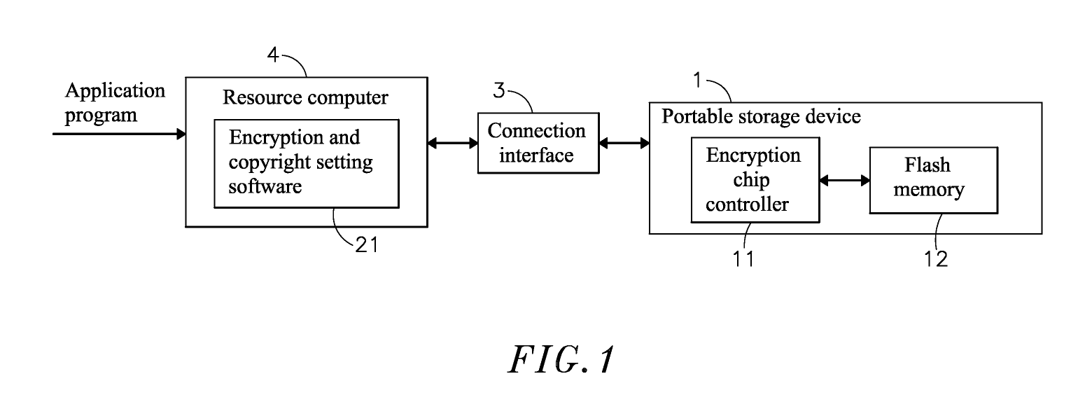

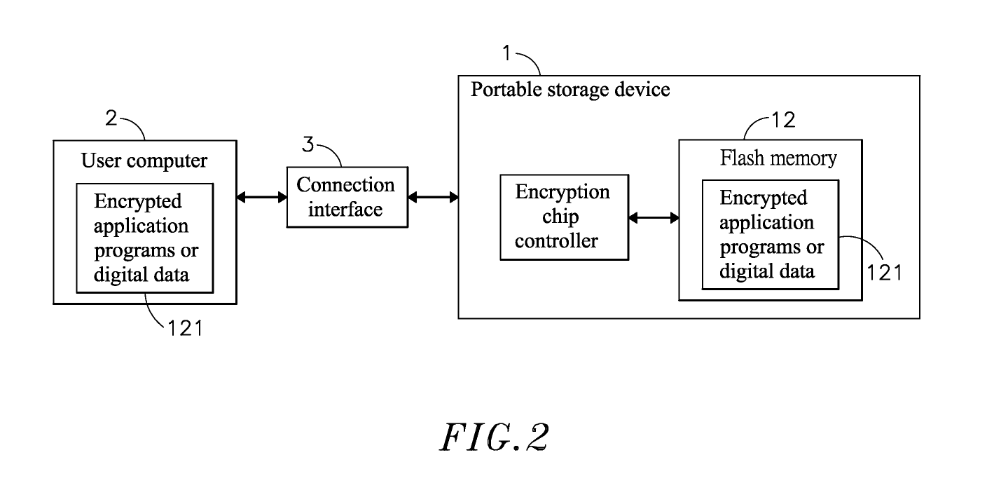

Referring to FIGS. 1 and 2, the present invention is shown comprised of a portable storage device 1 and encryption and copyright setting software 21.

The portable storage device 1 comprises an encryption chip controller 11 and a flash memory 12. The encryption chip controller 11 has encrypting and decrypting function, and the flash memory 12 has a rewritable integrated circuit for storing variety of application programs, digital data or multi-media data.

The encryption and copyright setting software 21 may encrypt or set up a copyright to the application programs or digital data. Thus, a provider of the application programs or digital data may encrypt a part or all of the application programs or digital data according to each copyright management scheme and store into the portable storage device 1.

A user computer 2 and a resource computer 4 are platforms with operation software, calculation function, storage devices and input/output devices. The user computer 2 may interact with the resource computer 4 or other external servers for downloading or storing application programs or digital data.

A connection interface 3 serves as a transmission interface between the portable storage device 1 and the user computer 2 or the resource computer 4. The connection interface 3 may be a driver program interface or an application program interface, and the portable storage device 1 may transmit verified digital data to the user computer 2 via the connection interface 3

Referring to FIGS. 1 and 2 again, the provider of the application programs or digital data may encrypt or set up the copyright to the application programs or digital data via the resource computer 4 and the encryption and copyright setting software 21, and according each copyright management scheme store the application programs or digital data into the portable storage device 1 via the connection interface 3 to form an encrypted application programs or digital data 121. After storing the encrypted application programs or digital data 121 into the portable storage device 1, the portable storage device 1 may be a carrier for dispersing or selling the encrypted application programs or digital data 121. Further, when a user uses the encrypted application programs or digital data 121 stored in the portable device 1, the encryption chip controller 11 may provide a verification function to make the portable storage device 1 as an anti-pirating hardware key for allowing only an authorized user to copy, disperse or use the encrypted application programs or digital data 121. The portable storage device 1 not only serves as a hardware key or a carrier, but also provides a digital copyright management function or a network authorization and verification function to protect the provider of the application programs and digital data. Furthermore, if a user wishes to obtain or renew the copyright, the user may retrieve a copyright verification or a user's authorization of the original application programs or digital data through the network and store into the portable storage device 1.

An encoding method of the encryption chip controller 11 may comprise an advanced encryption standard, a RSA (Rivest Shamir Adleman encryption) or other methods with encoding/decoding function.

The above copyright verification or the user's authorization may be permanent, time limited, frequency limited, user limited, partial function limited or other limited method.

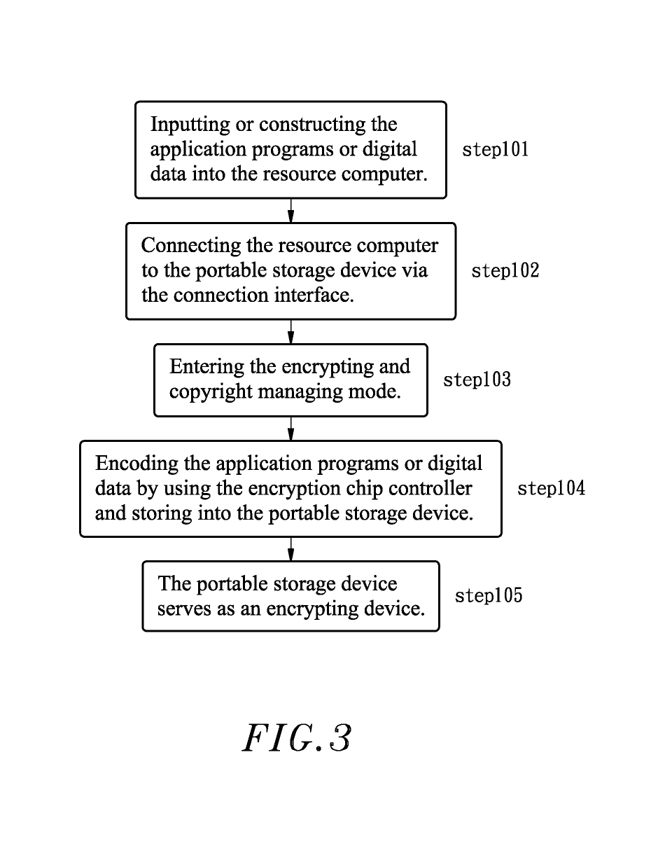

Referring to FIGS. 1 and 3, the copyright management procedure of the present invention is described as follows.

In step 101, a provider inputs or constructs the application programs or digital data into the resource computer 4, and then the procedure proceeds to step 102.

In step 102, the resource computer 4 is connected to the portable storage device 1 via the connection interface 3, and then the procedure proceeds to step 103.

In step 103, the provider of the application programs or the digital data enters the encryption and copyright managing mode, and then the procedure proceeds to step 104.

In step 104, the application programs or digital data are encrypted by the encryption chip controller 11 and stored into the portable storage device 1, and then the procedure proceeds to step 105.

In step 105, the portable storage device 1 serves as a carrier for dispersing the application programs or digital data, an anti-pirating hardware key and an encrypting device with the digital copyright management function or the network authorization and verification function.

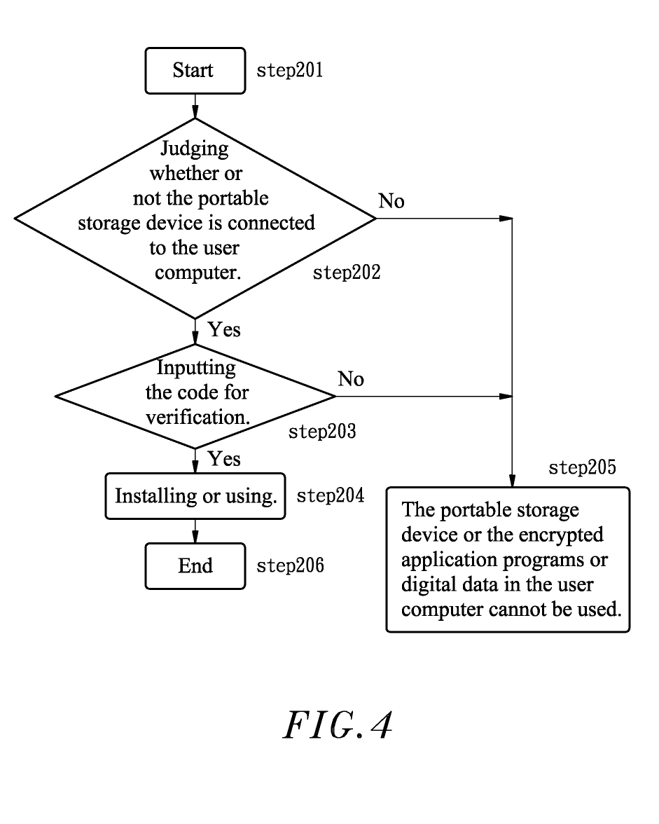

Referring to FIGS. 2 and 4, the procedure for executing the portable device as the hardware key of the present invention is described as follows.

In step 201, the procedure is initiated.

In step 202, judging whether the portable storage device 1 is connected to the user computer 2, and if the portable device 1 is not connected to the user computer 2, then the procedure proceeds to step 205.

In step 203, a user of the application programs or digital data inputs a code for verification, and if the verification fails, the procedure proceeds to step 205.

In step 204, the user installs or uses the encrypted application programs or digital data 121 via the user computer 2, and then the procedure proceeds to step 206.

In step 205, the user cannot use the portable storage device 1 or the encrypted application program or digital information 121 stored in the user computer 2.

In step 206, the procedure is ended.

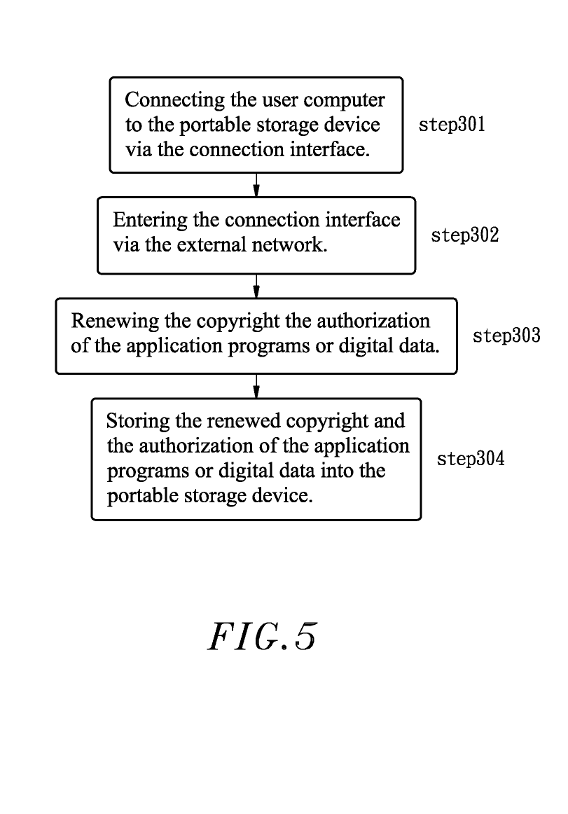

Referring to FIGS. 2 and 5, the procedure for renewing the copyright or the authorization of the present invention is described as follows.

In step 301, the user computer 2 is connected to the portable storage device 1 via the connection interface 3, and then the procedure proceeds to step 302.

In step 302, a user enters into the connection interface 3 via the external network, and then the procedure proceeds to step 303.

In step 303, the copyright and the authorization of the application program or digital data is renewed, and then the procedure proceeds to step 304.

In step 304, the renewed copyright and the authorization of the application program or digital data are stored into the portable storage device 1.

Accordingly, the portable storage device and system of the present invention has the following advantages.

1. The encryption chip controller 11 of the portable storage device 1 has the encrypting/decrypting function. Thus, a provider of the application program or digital data may use the encryption and copyright setting software 21 to store the partially or all encrypted application program or digital data 121 into the portable storage device 1. Accordingly, the portable storage device 1 may serve as a carrier for dispersing the application program or digital data. Furthermore, a user of the application program or digital data may verify whether or not the portable storage device 1 is connected to the user computer 2 via the user computer 2. So the portable storage device 1 may also be applied as an anti-pirating hardware key to protect the application program or digital data stored in the portable storage device 1. Thus, the application program or digital data cannot be copied, dispersed or used by a unauthorized user to protect the provider.

2. A user may use the user computer 2 to renew or purchase various application programs or digital data through the network. Because the authorization may be permanent, time limited, frequency limited, user limited, function limited or other authorization limited, the provider of the application program or digital data can verify whether or not the user is legal to prevent pirating. Compared to the conventional art, which uses a CD as the carrier and require inputting a software serial number or a registered code to verify, the portable storage device of the present invention is more advantageous for use and carriage. Besides, the provider of the application program or digital data can set the limit to the user according to the user's authorization.

3. When the portable storage device 1 is as a hardware key, a secret code further can be used for verifying. In addition, upon a user's authorization, for example, by limiting the use frequency, the user can ensure that the application program or digital data will not be illegally dispersed or used.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A portable storage system with hardware key and copyright management function, comprising:
encryption and copyright setting software, for encrypting application programs or digital data; and
a portable storage device, comprising an encryption chip controller and a flash memory so that said portable storage device can serve as a dispersing carrier, a hardware key or an encrypting device with digital copyright management function or network authorization and verification function, wherein said encryption chip controller comprises encrypting and decrypting functions and said flash memory comprises a rewritable integrated circuit.

2. The portable storage system with hardware key and copyright management function according to claim 1, further comprising a connection interface for connecting between said portable storage device and a user computer or a resource computer, and said connection interface can be a driver program interface or an application program interface.

3. The portable storage system with hardware key and copyright management function according to claim 1, wherein an encoding method of said encryption chip controller can be an advanced encryption standard or RSA (Rivest Shamir Adleman encryption).

4. The portable storage system with hardware key and copyright management function according to claim 1, wherein said digital copyright management or said network authorization and verification can be permanent, time limited, frequency limited, user limited or function limited.

5. The portable storage system with hardware key and copyright management function according to claim 1, wherein a copyright or an authorization of said application program or digital data can be renewed through network, and said renewed application program or digital data can be stored in said portable storage device.

6. A portable storage device with hardware key and copyright management function, comprising:
a flash memory, comprising a rewritable integrated circuit for storing various encrypted application programs, digital data or multi-media data; and
an encryption chip controller with encrypting and decrypting function, wherein application programs or digital data can be encrypted/decrypted by encryption and copyright setting software in a resource computer and stored in said portable storage device.

7. The portable storage device with hardware key and copyright management function according to claim 6, wherein a encrypting method of said encryption chip controller can be an advanced encryption standard or a RSA (Rivest Shamir Adleman encryption).

8. The portable storage device with hardware key and copyright management function according to claim 6, wherein a copyright or an authorization of said application program or digital data can be renewed through network, and said renewed application program or digital data can be stored in said portable storage device.

9. The portable storage device with hardware key and copyright management function according to claim 6, wherein said portable storage device can be a dispersing carrier, a hardware key or an encrypting device with digital copyright management function or network authorization and verification function.

10. The portable storage device with hardware key and copyright management function according to claim 9, wherein said digital copyright management or said network authorization and verification can be permanent, time limited, frequency limited, user limited or function limited.

11. A method of executing a portable storage system with hardware key and copyright management function, comprising:
(a) inputting or constructing application programs or digital data in a resource computer;
(b) connecting said resource computer to a portable storage device via a connection interface;
(c) entering an encrypting and copyright managing mode; and
(d) encrypting said application programs or digital data by using an encryption chip controller and storing into said portable storage device, so that said portable storage device can serve as a hardware key, a dispersing carrier or an encrypting device with digital copyright management function or network authorization and verification function.
